(19) United States
(12) Patent Application Publication
(10) Pub. No.: US 2026/0010087 A1
(43) Pub. Date: Jan. 8, 2026

(54) CYLINDRICAL MEMBER, ELASTIC ROLLER FOR ELECTROPHOTOGRAPHY, PROCESS CARTRIDGE, AND ELECTROPHOTOGRAPHIC APPARATUS

(71) Applicant: CANON KABUSHIKI KAISHA, Tokyo (JP)

(72) Inventors: KENICHI YAZAWA, Shizuoka (JP); MASAHIRO INAMI, Shizuoka (JP); TOSHIRO SUZUKI, Shizuoka (JP)

(21) Appl. No.: 19/253,136

(22) Filed: Jun. 27, 2025

(30) Foreign Application Priority Data
Jul. 2, 2024 (JP) 2024-106837

(51) Int. Cl. G03G 15/02; G03G 21/18

(52) U.S. Cl. CPC G03G 15/0233; G03G 21/1814

(57) ABSTRACT

In the XY coordinate plane having the origin at a centroid of area K, at least one of centroids D1 to D9 of areas lies outside of a circle centered at the centroid K of area with a radius of 10 μm. In the XY coordinate plane having the origin at the centroid K of area, all of the centroids D1 to D9 of areas lie in the first quadrant of the XY coordinate plane having the origin at the centroid K of area.

### BACKGROUND

### Field of the Technology

The present disclosure relates to a cylindrical member, an elastic roller and a process cartridge for electrophotography, and an electrophotographic apparatus.

### Description of the Related Art

In electrophotographic apparatuses (electrophotographic image forming apparatuses), elastic rollers for electrophotography that are disposed in contact with a photosensitive drum are used. Examples of the elastic roller for electrophotography include a charge roller, a developing roller, and a transfer roller (hereinafter simply referred to as “elastic rollers”). An elastic roller can also be used as a paper feed roller of an electrophotographic apparatus.

Elastic rollers are required to have a low runout with respect to the outer diameter and the central axis, that is, high precision (high shape accuracy). In general, elastic rollers are produced by coating an elastic layer around a cylindrical member that serves as a core metal. Therefore, the cylindrical member that serves as the core metal is also required to have a low runout with respect to the outer diameter and the central axis, that is, to have high accuracy (high shape accuracy).

The cylindrical member that serves as the core metal of the elastic roller is also required to have a high degree of uniformity in its physical properties.

If the shape accuracy of the cylindrical member is low or the nonuniformity of physical properties of the cylindrical member is high, the elastic roller that is disposed in contact with the photosensitive drum is likely to have uneven contact with the photosensitive drum, which may cause the nonuniformity in an output image. In addition, when the elastic roller is used as a paper feed roller, the elastic roller may cause paper jamming or skew.

For cylindrical members that have low shape accuracy and bend, the shape accuracy of the cylindrical member can be improved by applying a load (straightening load) in the direction opposite to the direction of the bend of the bent portion of the cylindrical member to push the bent portion into the cylindrical member and straighten the cylindrical member (plastic forming). Japanese Patent Laid-Open No. 2001-150029 describes an indenter for straightening a cylindrical member (an indenter for applying a load to a cylindrical member). In addition, Japanese Patent No. 4419224 describes straightening of a cylindrical member by measuring runouts at a plurality of points in the longitudinal direction of the cylindrical member.

### SUMMARY

The present disclosure provides a cylindrical member with low runout and low nonuniformity of physical properties (the degree of work hardening) in the longitudinal direction.

According to an aspect of the present disclosure, a cylindrical member made of metal is provided. Let A denote a centroid of area of one end surface of the cylindrical member, let B denote a centroid of area of another end surface, let Z-axis denote a line passing through the centroid A of area and the centroid B of area, let Y-axis denote a line perpendicular to the Z-axis, let X-axis denote a line perpendicular to the Z-axis and the Y-axis, let AB denote a line segment connecting the centroid A of area to the centroid B of area, let E1 to E9 denote nine points that divide the line segment AB into 10 equal parts from a side adjacent to the centroid A of area, let Q1 to Q9 denote nine planes each including any one of the points E1 to E9 and parallel to the Y-axis, let S1 to S9 denote nine virtual cross sections obtained by virtually cutting the cylindrical member by the planes Q1 to Q9, respectively, and let C1 to C9 denote centroids of areas of the virtual cross sections S1 to S9, respectively, then when positions of the centroids C1 to C9 of areas relative to the centroid A of area are plotted on an XY coordinate plane having an origin at the centroid A of area, all of the centroids C1 to C9 of areas lie on or within a circle centered at the centroid A of area with a radius of 10 μm in the XY coordinate plane having an origin at the centroid A of area. After the cylindrical member is heated until a temperature of the entire cylindrical member reaches a recrystallization temperature of the metal to obtain the heated cylindrical member, let K denote a centroid of area of one end surface of the heated cylindrical member on the same side as the centroid A of area, let L denote a centroid of area of the other end surface on the same side as the centroid B of area, let Z-axis denote a line passing through the centroid K of area and the centroid L of area, let Y-axis denote a line perpendicular to the Z-axis, let X-axis denote a line perpendicular to the Z-axis and the Y-axis, let KL denote a line segment connecting the centroid K of area to the centroid L of area, let F1 to F9 denote nine points that divide the line segment KL into 10 equal parts from a side adjacent to the centroid K of area, let R1 to R9 denote nine planes each including any one of the points F1 to F9 and parallel to the Y-axis, let T1 to T9 denote nine virtual cross sections obtained by virtually cutting the heated cylindrical member by the planes R1 to R9, respectively, and let D1 to D9 denote centroids of areas of the virtual cross sections T1 to T9, respectively, then when positions of the centroids D1 to D9 of areas relative to the centroid K of area are plotted on the XY coordinate plane having the origin at the centroid K of area, at least one of the centroids D1 to D9 of areas lies outside of a circle centered at the centroid K of area with a radius of 10 μm in the XY coordinate plane having an origin at the centroid K of area. Let Dmax denote the farthest one out of the centroids D1 to D9 of areas from the centroid K of area, let KDmax denote a half line passing through the centroid K of area and the centroid Dmax of area and having an end point at the centroid K of area, and let a reference half line be a half line that lies in a first quadrant of the XY coordinate plane having the origin at the centroid K of area and passes through the centroid K of area and that has an end point at the centroid K of area and has a slope of 1, then when the half line KDmax is made to coincide with the reference half line, all of the centroids D1 to D9 of areas in the XY coordinate plane having an origin at the centroid K of area lie in the first quadrant of the XY coordinate plane having an origin at the centroid K of area.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic illustration of the appearance of a cylindrical member.

FIG. 2 is a schematic illustration of the appearance of a measuring instrument used to measure the shape of a cylindrical member.

FIGS. 3 and 13 are schematic illustrations of the locations of the centroids of areas of virtual cross sections of a cylindrical member.

FIG. 4 is a schematic illustration of the positions of the centroids of areas of virtual cross sections of a cylindrical member that are projected on an XY coordinate plane.

FIG. 5 is a schematic illustration of the positions of the centroids of areas of virtual cross sections of a heated cylindrical member that are projected on the XY coordinate plane.

FIG. 6 is a schematic illustration of the appearance of a cylindrical member straightening jig.

FIG. 7 is a schematic illustration of the appearance of a cylindrical member being straightened by the straightening jig.

FIG. 8 is a schematic illustration of the appearance of the cylindrical member after straightened by the straightening jig.

FIG. 9 is a schematic illustration of the positions of centroids of areas of the cylindrical member that are projected on the XY coordinate plane after straightening.

FIG. 10 is a schematic illustration of the appearance of an elastic roller for electrophotography.

FIG. 11 is a schematic illustration of the structure of a crosshead extrusion equipment.

FIG. 12 illustrates a method for determining whether a cylindrical member is the cylindrical member according to the present disclosure.

### DESCRIPTION OF THE EMBODIMENTS

An elastic roller with high runout and/or high nonuniformity of physical properties is likely to develop soiling due to adhesion of toner and external additive for the toner to the surface with use. Nonuniformity (light and heavy uneven soiling) may occur in the circumferential direction of the elastic roller.

The present inventors have found that the soiling on an elastic roller was influenced by nonuniformity of physical properties in the longitudinal direction of the cylindrical member of the elastic roller, in addition to the shape accuracy of the cylindrical member. As used herein, the term “physical properties” refers to the degree of work hardening. The present inventors presume that the nonuniformity in the degree of work hardening of the cylindrical member causes the nonuniformity of the elastic coefficient of the cylindrical member.

By heating the cylindrical member until the entire cylindrical member reaches the recrystallization temperature of the metal that is the material of the cylindrical member, the metal recovers from work hardening. The present inventors found that the nonuniformity in the degree of the work hardening in the longitudinal direction of the cylindrical member was able to be estimated by measuring the shape of the cylindrical member after heating (hereinafter referred to as a “heated cylindrical member”).

There are two types of straightening of the cylindrical member that has runout (bend): straightening performed such that the direction of runout remains the same before and after straightening, and straightening performed such that the direction of runout after the straightening is changed to the extent that the direction is reversed.

If the cylindrical member is straightened to the extent that the direction of runout is not reversed, the shape of the cylindrical member when the temperature is increased to the recrystallization temperature is an arc shape with only one inflection point.

However, if a cylindrical member that is straightened to an extent that reverses the direction of runout of the cylindrical member is heated to the recrystallization temperature, the shape of the cylindrical member becomes like a cubic curve with two inflection points. In general, the cylindrical member of an elastic roller is manufactured through a rolling process. The present inventors presume that the shape of the heated cylindrical member that resembles a cubic curve with two inflection points is significantly influenced by both the rolling process and the subsequent straightening process.

The present inventors have found that when the heated cylindrical member obtained by heating a cylindrical member until the entire cylindrical member reaches the recrystallization temperature of the metal have an arc shape with only one inflection point, the cylindrical member is a high precision cylindrical member having low nonuniformity in the degree of work hardening in the longitudinal direction.

A cylindrical member according to the present disclosure is described below.

### Cylindrical Member

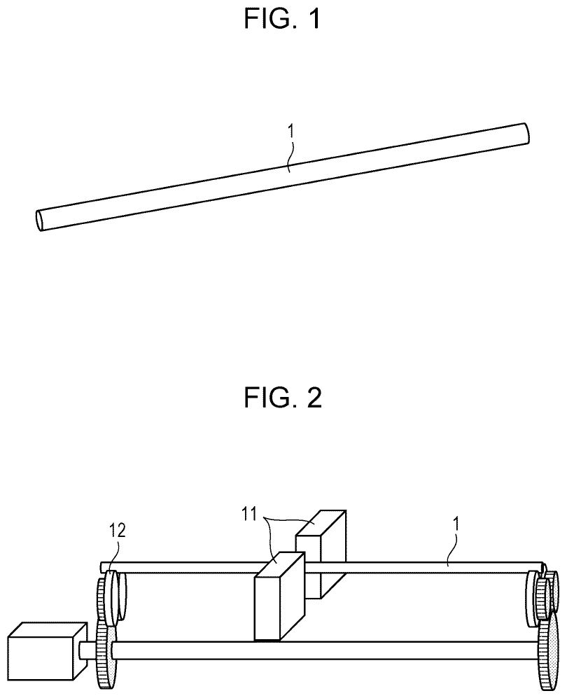

FIG. 1 is a schematic illustration of the appearance of the cylindrical member.

A cylindrical member 1 is made of metal (a metal cylindrical member). According to the present disclosure, the examples of the metal include alloys. For example, the examples of the metal from which the cylindrical member 1 is made include iron, copper, stainless steel, aluminum, and nickel. The surface of the cylindrical member 1 may be plated to provide scratch resistance, for example.

### Method for Measuring Cylindrical Member

FIG. 2 is a schematic illustration of the appearance of a measuring instrument used to measure the shape of a cylindrical member.

As illustrated in FIG. 2, the cylindrical member 1 is placed between a light emitting portion (front side) and a light receiving portion (back side) of a measuring instrument 11 such that the optical path of a laser beam is perpendicular to the longitudinal direction of the cylindrical member 1. A laser beam is emitted from the light emitting portion to the cylindrical member 1 while a gripping portion 12 that grasps the cylindrical member 1 is being rotated and, thus, the cylindrical member 1 is being passively rotated. The laser beam emitted from the light emitting portion is blocked by the cylindrical member 1 or reaches the light receiving portion without being blocked and, thus, the shape of the cylindrical member 1 can be measured.

A virtual cross section perpendicular to the longitudinal direction of cylindrical member 1 is approximated by a least-squares circle, and the point at which the center of the least-squares circle is projected onto the virtual cross section is defined as the centroid of area of the virtual cross section.

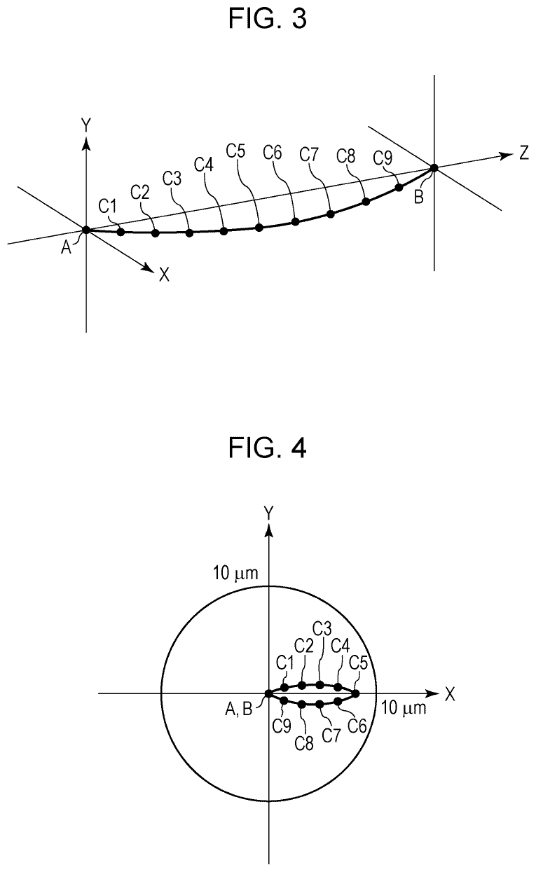

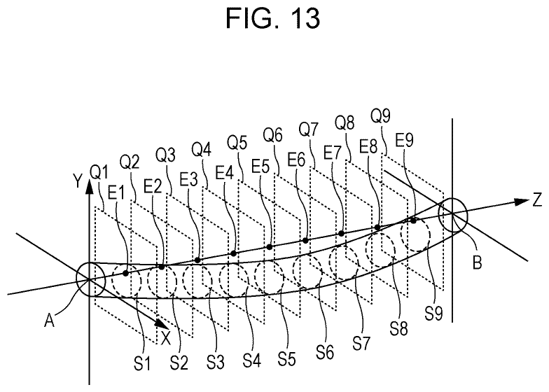

FIGS. 3 and 13 are schematic illustrations of the locations of the centroids of areas of virtual cross sections of a cylindrical member.

Let A denote the centroid of area of one end surface of the cylindrical member 1. Let B denote the centroid of area of the other end surface of the cylindrical member 1. Let Z-axis denote a line passing through the centroid A of area and the centroid B of area. The Z-axis is the central axis based on the centroids of areas of the two end surfaces of the cylindrical member 1. Let Y-axis denote a line perpendicular to the Z-axis. Let X-axis denote a line perpendicular to the Z-axis and the Y-axis. Let AB denote a line segment connecting the centroid A of area to the centroid B of area. Let E1 to E9 denote nine points that divide the line segment AB into 10 equal parts, from a side adjacent to the centroid A of area. Let Q1 to Q9 denote nine planes each including any one of the points E1 to E9 and parallel to the Y-axis.

The points in the longitudinal direction of the cylindrical member 1 measured by the measuring instrument 11 are nine points on the planes Q1 to Q9. Measurements at the nine measuring points may be performed one by one by moving a single measuring instrument 11. Alternatively, a plurality of measuring instruments 11 may be installed at the plurality of measuring points, and the plurality of points may be measured simultaneously.

Let S1 to S9 denote nine virtual cross sections obtained by virtually cutting the cylindrical member by the planes Q1 to Q9, respectively. Let C1 to C9 denote the centroids of areas of the virtual cross sections S1 to S9, respectively.

FIG. 4 is a schematic illustration of projection of the positions of the centroids C1 to C9 of areas of the virtual cross sections of the cylindrical member 1 onto the XY coordinate plane having the origin at the centroid A of area.

The positions of the centroids C1 to C9 of areas relative to the centroid A of area are plotted on the XY coordinate plane having the origin at the centroid A of area. At this time, it is desirable that all of the centroids C1 to C9 of areas be on or within a circle centered at the centroid A of area with a radius of 10 μm in the XY coordinate plane having the origin at the centroid A of area.

### Heating Method

A cylindrical member made of metal is heated to the recrystallization temperature of the metal. The heating time varies with the shape of the metal and a heating unit, so that the entire cylindrical member is heated until it reaches the recrystallization temperature of the metal. Examples of the heating unit include a hot air furnace, a vulcanizing can, a hot plate, a far or near infrared ray, and an induction heating unit. After heating, the cylindrical member is cooled at room temperature until it reaches 35° C. or lower. In this manner, a heated cylindrical member is obtained.

### Method for Measuring Heated Cylindrical Member

The measurement of the shape of the heated cylindrical member is performed in the same manner as the measurement of the shape of the cylindrical member 1 (the cylindrical member before heating).

Let K (not illustrated) denote the centroid of area of one end surface of the heated cylindrical member on the same side as the centroid A of area. Let L (not illustrated) denote the centroid of area of the other end surface of the heated cylindrical member on the same side as the centroid B of area. Let Z-axis denote a line passing through the centroid K of area and the centroid L of area. The Z-axis is the central axis based on the centroids of areas of the two end surfaces of the heated cylindrical member. Let Y-axis denote a line perpendicular to the Z-axis. Let X-axis denote a line perpendicular to the Z-axis and the Y-axis. Let KL denote a line segment connecting the centroid K of area to the centroid L of area. Let F1 to F9 denote nine points that divide the line segment KL (not illustrated) into 10 equal parts, from a side adjacent to the centroid K of area. Let R1 to R9 (not illustrated) denote nine planes each including any one of the points F1 to F9 (not illustrated) and parallel to the Y-axis.

The points in the longitudinal direction of the heated cylindrical member 1 measured by the measuring instrument 11 are nine points on the planes R1 to R9. Measurements at the nine measuring points may be performed one by one by moving a single measuring instrument 11. Alternatively, a plurality of measuring instruments 11 may be installed at the plurality of measuring points, and the plurality of points may be measured simultaneously.

Let T1 to T9 denote nine virtual cross sections obtained by virtually cutting the heated cylindrical member by the planes R1 to R9, respectively. Let D1 to D9 denote the centroids of areas of the virtual cross sections T1 to T9, respectively.

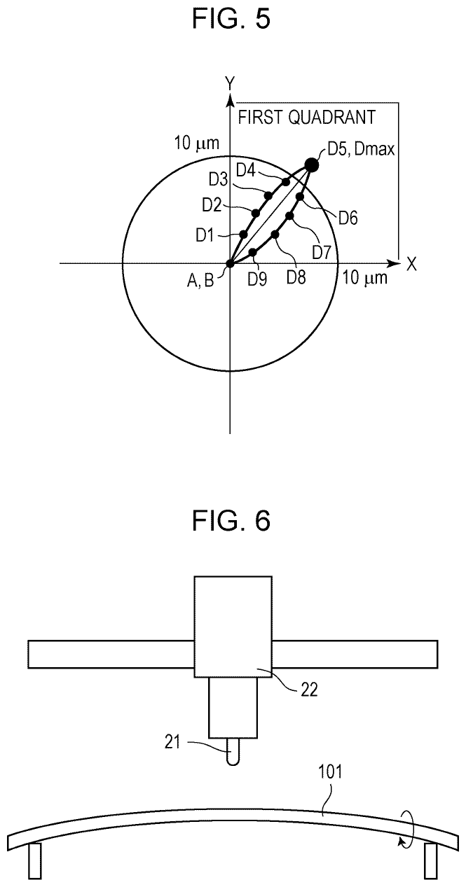

FIG. 5 is a schematic illustration of projection of the positions of the centroids D1 to D9 of areas of the virtual cross sections of the heated cylindrical member 1 onto the XY coordinate plane having the origin at the centroid K of area.

The positions of the centroids D1 to D9 of areas relative to the centroid K of area are plotted on the XY coordinate plane having the origin at the centroid K of area. At this time, it is desirable that at least one of the centroids D1 to D9 of areas lie outside of a circle centered at the centroid K of area with a radius of 10 μm in the XY coordinate plane having the origin at the centroid K of area.

In the XY coordinate plane having the origin at the centroid K of area, let Dmax denote the farthest one out of the centroids D1 to D9 of areas from the centroid K of area. It is desirable that the centroid Dmax of area lie on or within a circle centered at the centroid K of area with a radius of 100 μm.

Let KDmax denote a half line passing through the centroid K of area and the centroid Dmax of area and having the end point at the centroid K of area. A half line that lies in a first quadrant of the XY coordinate plane having the origin at the centroid K of area and passes through the centroid K of area and that has the end point at the centroid K of area and has a slope of 1 is used as a reference half line. When the half line KDmax is made to coincide with the reference half line, it is desirable that all of the centroids D1 to D9 of areas in the XY coordinate plane having the origin at the centroid K of area lie in the first quadrant of the XY coordinate plane having the origin at the centroid K of area.

### Method for Straightening Bend of Cylindrical Member

### Straightening Jig

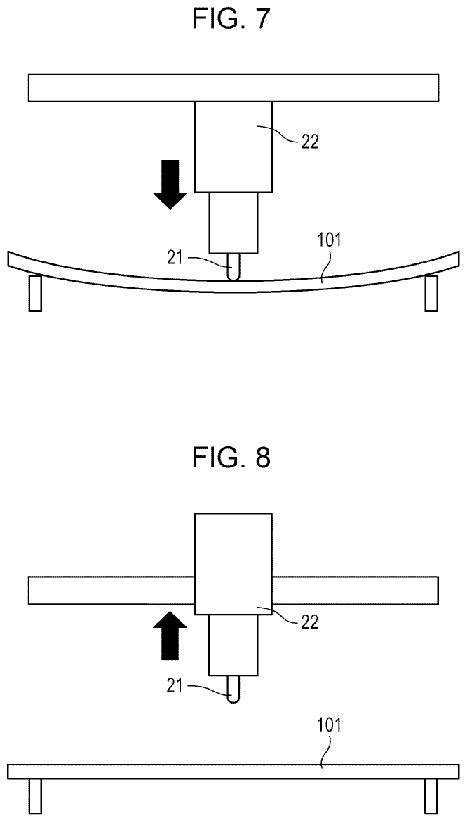

FIG. 6 is a schematic illustration of the appearance of a straightening jig for a cylindrical member. It is desirable that a loading jig 21 have a shape and a material that can straighten a cylindrical member 101 and is less likely to damage the surface of the cylindrical member 101. FIG. 7 is a schematic illustration of the appearance of the cylindrical member 101 being straightened by the straightening jig. FIG. 8 is a schematic illustration of the appearance of the cylindrical member 101 after being straightened by the straightening jig.

### Straightening Method

Before being straightened, the cylindrical member 101 is measured.

In the measurement system of the cylindrical member 101 before straightening, let Cmax denote, among centroids C101 to C109 of areas that are nine centroids of areas other than a centroid 10A of area of one end surface and a centroid 10B of area of the other end surface of the cylindrical member 101 before straightening, the position of the farthest centroid of area from the origin of the XY coordinate plane. The centroids 10A, 10B, and C101 to C109 of areas are determined in the same manner as the centroids A, B, and C1 to C9 of areas, respectively. The cylindrical member 1 is rotated so that the position Cmax is located on the upper side in the gravitational direction, as necessary. Then, as illustrated in FIG. 7, a robot 22 moves a loading jig 21 toward the cylindrical member 101 from the upper side to the lower side in the gravitational direction to press the cylindrical member 101 and straighten the cylindrical member 101 so that the amount of runout of the cylindrical member 101 decreases. Thereafter, as illustrated in FIG. 8, the robot 22 moves the loading jig 21 from the lower side to the upper side in the gravitational direction to separate the loading jig 21 from the cylindrical member 101.

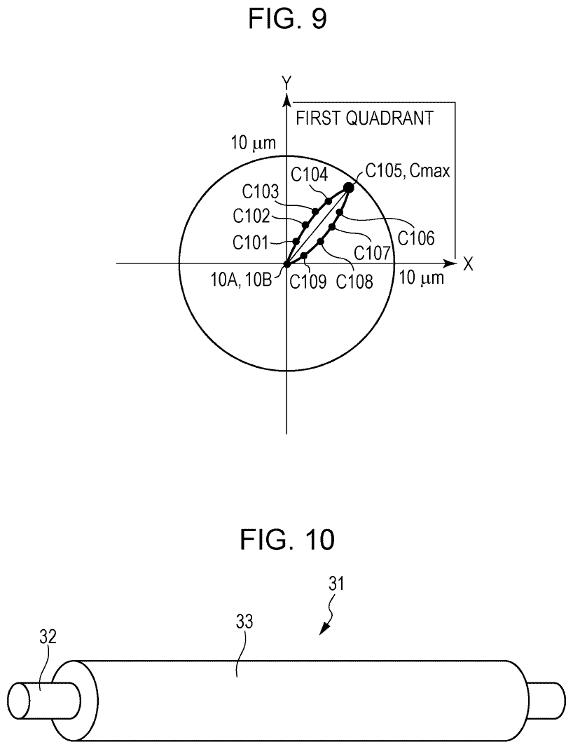

As illustrated in FIG. 9, in the XY coordinate plane having the origin at the centroid 10A (10B) of area, let ACmax (not illustrated) denote a half line passing through the centroid 10A (10B) of area and the position Cmax and having the end point at the centroid 10A (10B) of area. A half line that lies in the first quadrant of the XY coordinate plane having the origin at the centroid 10A (10B) of area and passes through the centroid 10A (10B) of area and that has the end point at the centroid 10A (10B) of area and has a slope of 1 is used as a reference half line. Then, the half line ACmax is made to coincide with the reference half line. At this time, it is desirable that straightening be made so that all of the centroids C101 to C109 of areas lie in the first quadrant of the XY coordinate plane having the origin at the centroid 10A (10B) of area. It is also desirable that straightening is made so that the distance of the position Cmax from the centroid 10A (10B) of area in the XY coordinate plane having the origin at the centroid 10A (10B) is less than or equal to 20 μm.

### Method for Measuring Circularity of Cylindrical Member

Circularity measurement can be performed on the cross section of the cylindrical member at the middle in the longitudinal direction with reference to the outer peripheral surfaces of both the end portions of the cylindrical member by using a non-contact laser measuring instrument or a circularity measuring instrument. When a non-contact laser measuring instrument is used, both of the end portions of the cylindrical member are received by V-shaped blocks or the like, and the outer diameter of the cylindrical member is measured while the cylindrical member is being rotated. Then, the value (maximum value−minimum value of the measured outer diameter)/2 is calculated.

### Elastic Roller

FIG. 10 is a schematic illustration of the appearance of an elastic roller for electrophotography.

An elastic roller 31 includes a core metal 32 and an elastic layer 33 that covers the peripheral surface of the core metal 32. Both ends of the core metal 32 may be exposed without being covered by the elastic layer 33.

A charge roller, which is one example of elastic rollers for electrophotography, is used as a charging unit to charge a photosensitive drum in an electrophotographic apparatus. For example, the charge roller is disposed in contact with the photosensitive drum. The charge roller rotates in accordance with the rotation of the photosensitive drum and charges the surface of the photosensitive drum in or near a contact portion between the photosensitive drum and the charge roller.

The developing roller, which is another example of elastic rollers for electrophotography, is used as a unit for stably supplying toner to the surface of the photosensitive drum. For example, the developing roller is disposed in contact with the photosensitive drum.

### Elastic Layer

The elastic layer 33 may be a solid layer or a foam layer. In addition, the elastic layer 33 may have a single layer structure or a multilayer structure. It is desirable that the Asker C hardness scale of the elastic layer 33 be greater than or equal to 10 degrees and less than or equal to 70 degrees. If the Asker C hardness scale of the elastic layer 33 is greater than or equal to 10 degrees, exudation of oil components and other substances from a rubber material that forms the elastic layer 33 can be easily prevented. Prevention of exudation of oil components can prevent soiling of a member, such as a photosensitive drum, in contact with the elastic roller. If the Asker C hardness scale of the elastic layer 33 is less than or equal to 70 degrees, contact between the elastic roller and the member is stably ensured. The stably ensured contact can prevent degradation of the quality of an output image. As used herein, the term “Asker C hardness scale” refers to a value obtained by measuring a test piece separately prepared in accordance with the Asker C type SRIS 0101 standard (the standard by The Society of Rubber Science and Technology, Japan) using an Asker rubber hardness tester (available from Kobunshi Keiki Co., Ltd.).

### Material for Forming Elastic Layer

It is desirable that the elastic layer contain binder resin and conductive particles.

Examples of a binder resin include a variety of rubbers and thermoplastic elastomer. Examples of a rubber include natural rubber, butadiene rubber, styrene butadiene rubber (SBR), nitrile rubber, ethylene propylene diene monomer rubber (EPDM), chloroprene rubber (CR), acrylonitrile butadiene rubber (NBR), epichlorohydrin rubber, butyl rubber, silicone rubber, urethane rubber, fluorine rubber, and chlorine rubber. Among these, NBR is desirable from the viewpoint of preventing permanent deformation due to the compression and obtaining moderate hardness. In terms of NBR, an NBR having a nitrile content of 30% or higher and less than 36% (so called medium to high nitrile) is desirable. An example of medium to high nitrile NBR is N230SV (trade name) available from JSR Corporation.

Examples of conductive particles include particles made of Ketjen black EC, acetylene black, rubber carbon, oxidized color (ink) carbon, and pyrolytic carbon. Examples of rubber carbon include Super Abrasion Furnace (SAF, super abrasion resistance), Intermediate Super Abrasion Furnace (ISAF, intermediate super abrasion resistance), High Abrasion Furnace (HAF, high abrasion resistance), Fast Extrusion Furnace (FEF, adequate extrudability), General Purpose Furnace (GPF, general purpose), Semi ReinForcing Furnace (SRF, medium reinforcement), Fine Thermal (FT, fine particle thermal decomposition), and Medium Thermal (MT, medium particle thermal decomposition). Alternatively, graphite, such as natural graphite or artificial graphite, can also be used. Examples of the conductive particles include metal oxide particles, such as TiO₂, SnO₂, and ZnO, double oxide particles, such as solid solution of ZnO and Al₂O₃, and metal powders, such as Cu and Ag. Only one type of these conductive particles may be used, or several types may be used together.

### Processes for Manufacturing Elastic Roller Precursor

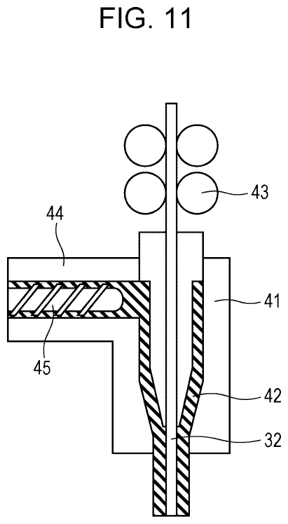

FIG. 11 is a schematic illustration of the structure of a crosshead extrusion equipment.

One method for manufacturing an elastic roller, for example, is to use an extrusion equipment with a crosshead and form an elastic layer by covering the peripheral surface of a core metal with a material for forming an elastic layer (an elastic layer forming material). The extrusion equipment illustrated in FIG. 11 includes a crosshead 41. The extrusion equipment can coextrude the core metal 32 and an elastic layer forming material 42 to cover the peripheral surface of the core metal 32 with the elastic layer forming material 42 and, thus, form the elastic layer. The extrusion equipment illustrated in FIG. 11 includes the crosshead 41 into which the core metal 32 and the elastic layer forming material 42 are fed, a feed roller 43 that feeds the core metal 32 into the crosshead 41, and a cylinder 44 that feeds the elastic layer forming material 42 into the crosshead 41.

The elastic layer forming material 42 is fed into the crosshead 41, and the core metal 32 is fed into the crosshead 41 by a screw 45 in the cylinder 44 and, thus the core metal 32 having the peripheral surface covered with the elastic layer forming material 42 is discharged from the crosshead 41. A core metal having the peripheral surface covered with an elastic layer forming material is also referred to as an “elastic roller precursor”.

In addition to the above-described method, a method using a die can be employed in which the inside of the die is filled with the elastic layer forming material such that the peripheral surface of the core metal disposed in the die is covered with the elastic layer forming material and, thereafter, the elastic layer forming material is cured.

The peripheral surface of the elastic layer 33 formed by curing the elastic layer forming material 42 that covers the peripheral surface of the core metal 32 may be polished using a grinding stone or the like.

### Vulcanizing Process and Cut-Off Process

The elastic roller precursor may be heated by a unit, such as a hot air furnace, a vulcanizing can, a hot plate, a far infrared ray, a near infrared ray, or induction heating unit to vulcanize the elastic layer forming material. It is desirable that the heating temperature be in the range of 130° C. to 250° C., and it is more desirable that the heating temperature be in the range of 140° C. to 220° C. It is desirable that the heating time be in the range of 5 minutes to 240 minutes and, it is more desirable that the heating time be in the range of 10 minutes to 60 minutes.

The vulcanized rubber composition at both ends of the roller is removed in a subsequent process, and the elastic roller for electrophotography is achieved. Both ends of the core metal 32 of the elastic roller produced in this manner are exposed.

### Surface Treatment Process

The elastic roller may be subjected to surface treatment, such as UV irradiation to decrease the surface friction coefficient or electron beam irradiation to improve ηIT.

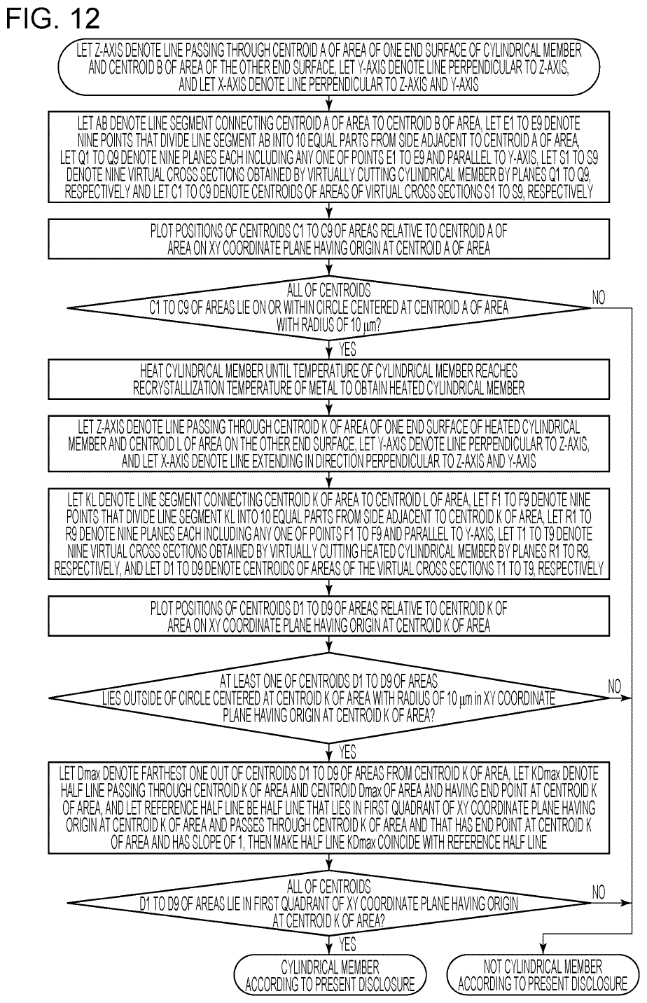

FIG. 12 illustrates a method for determining whether a cylindrical member is the cylindrical member according to the present disclosure.

### EXAMPLES

The technology according to the present disclosure is described in more detail below with reference to the examples.

The cylindrical members used in the examples and comparative examples are cylindrical members having a total length of 250 mm, an outer diameter of 5 mm, a material of carbon steel, a recrystallization temperature of 500° C., and a melting point of 1700° C.

### Example 1

The circularity of a cylindrical member before straightening was measured using a non-contact laser measuring instrument (trade name: LS-9000 available from Keyence Corporation) by receiving both end portions of the cylindrical member with V-shaped blocks and rotating the cylindrical member. In the examples and comparative examples described below, the circularities of cylindrical members were measured in the same manner. The circularity of the cylindrical member before straightening was greater than or equal to 5 μm.

The cylindrical member before straightening was straightened under the conditions of “Bend 1” described in Table 1 to obtain a cylindrical member 1 (the cylindrical member 1 after straightening). In this straightening, the positions of the centroids C101 to C109 of areas were not reversed.

In terms of the resulting cylindrical member 1, in the XY coordinate plane with the origin at the centroid A of area, all of the centroids C1 to C9 of areas laid within a circle centered at the centroid A of area with a radius of 10 μm.

The cylindrical member 1 was heated at 500° C. for 60 minutes to obtain the heated cylindrical member 1. The entire cylindrical member 1 reached the recrystallization temperature of the metal after being heated for 60 minutes. The same results were observed in the examples and comparative examples described below.

In terms of the heated cylindrical member 1, in the XY coordinate plane with the origin at the centroid K of area, the centroid Dmax of area was 15 μm away from the centroid K of area and laid outside of a circle centered at the centroid K of area with a radius of 10 μm. When the half line KDmax was made to coincide with the reference half line in the XY coordinate plane with the origin at the centroid K of area, all of the centroids D1 to D9 of areas laid in the first quadrant of the XY coordinate plane with the origin at the centroid K of area.

The results are illustrated in Table 2.

### Example 2

A cylindrical member having a circularity of 5 μm or greater before straightening was used.

The cylindrical member before straightening was straightened under the conditions of “Bend 2” described in Table 1 to obtain a cylindrical member 2 (a cylindrical member after straightening). In the straightening, the positions of the centroids C101 to C109 of areas were not reversed.

In terms of the resulting cylindrical member 2, in the XY coordinate plane with the origin at the centroid A of area, all of the centroids C1 to C9 of areas laid on or within a circle centered at the centroid A of area with a radius of 10 μm.

The cylindrical member 2 was heated at 500° C. for 60 minutes to obtain the heated cylindrical member 2.

In terms of the heated cylindrical member 2, in the XY coordinate plane with the origin at the centroid K of area, the centroid Dmax of area was 17 μm away from the centroid K of area and laid outside of a circle centered at the centroid K of area with a radius of 10 μm. When the half line KDmax was made to coincide with the reference half line in the XY coordinate plane with the origin at the centroid K of area, all of the centroids D1 to D9 of areas laid in the first quadrant of the XY coordinate plane with the origin at the centroid K of area.

The results are illustrated in Table 2.

### Example 3

A cylindrical member having a circularity of 5 μm or less before straightening was used.

The cylindrical member before straightening was straightened under the conditions of “Bend 3” described in Table 1 to obtain a cylindrical member 3 (a cylindrical member after straightening). In the straightening, the positions of the centroids C101 to C109 of areas were not reversed.

In terms of the resulting cylindrical member 3, in the XY coordinate plane with the origin at the centroid A of area, all of the centroids C1 to C9 of areas laid within a circle centered at the centroid A of area with a radius of 10 μm.

The cylindrical member 3 was heated at 500° C. for 60 minutes to obtain the heated cylindrical member 3.

In terms of the heated cylindrical member 3, in the XY coordinate plane with the origin at the centroid K of area, the centroid Dmax of area was 14 μm away from the centroid K of area and laid outside of a circle centered at the centroid K of area with a radius of 10 μm. When the half line KDmax was made to coincide with the reference half line in the XY coordinate plane with the origin at the centroid K of area, all of the centroids D1 to D9 of areas laid in the first quadrant of the XY coordinate plane with the origin at the centroid K of area.

The results are illustrated in Table 2.

### Example 4

A cylindrical member having a circularity of 5 μm or less before straightening was used.

The cylindrical member before straightening was straightened under the conditions of “Bend 4” described in Table 1 to obtain a cylindrical member 4 (a cylindrical member after straightening). In the straightening, the positions of the centroids C101 to C109 of areas were not reversed.

In terms of the resulting cylindrical member 4, in the XY coordinate plane with the origin at the centroid A of area, all of the centroids C1 to C9 of areas laid on or within a circle centered at the centroid A of area with a radius of 10 μm.

The cylindrical member 4 was heated at 500° C. for 60 minutes to obtain the heated cylindrical member 4.

In terms of the heated cylindrical member 4, in the XY coordinate plane with the origin at the centroid K of area, the centroid Dmax of area was 17 μm away from the centroid K of area and laid outside of a circle centered at the centroid K of area with a radius of 10 μm. When the half line KDmax was made to coincide with the reference half line in the XY coordinate plane with the origin at the centroid K of area, all of the centroids D1 to D9 of areas laid in the first quadrant of the XY coordinate plane with the origin at the centroid K of area.

The results are illustrated in Table 2.

### Comparative Example 1

A cylindrical member having a circularity of 5 μm or less before straightening was used.

The cylindrical member before straightening was straightened under the conditions of “Bend 5” described in Table 1 to obtain a cylindrical member 5 (a cylindrical member after straightening). In the straightening, the positions of the centroids C101 to C109 of areas were reversed.

In terms of the resulting cylindrical member 5, in the XY coordinate plane with the origin at the centroid A of area, all of the centroids C1 to C9 of areas laid within a circle centered at the centroid A of area with a radius of 10 μm.

The cylindrical member 5 was heated at 500° C. for 60 minutes to obtain the heated cylindrical member 5.

In terms of the heated cylindrical member 5, in the XY coordinate plane with the origin at the centroid K of area, the centroid Dmax of area was 13 μm away from the centroid K of area and laid outside of a circle centered at the centroid K of area with a radius of 10 μm. When the half line KDmax was made to coincide with the reference half line in the XY coordinate plane with the origin at the centroid K of area, some of the centroids D1 to D9 of areas laid in the first quadrant of the XY coordinate plane with the origin at the centroid K of area, some laid in the second quadrant, and some laid in the third quadrant.

The results are illustrated in Table 2.

### Comparative Example 2

A cylindrical member having a circularity of 5 μm or less before straightening was used.

The cylindrical member before straightening was straightened under the conditions of “Bend 6” described in Table 1 to obtain a cylindrical member 6 (a cylindrical member after straightening). In the straightening, the positions of the centroids C101 to C109 of areas were reversed.

In terms of the resulting cylindrical member 6, in the XY coordinate plane with the origin at the centroid A of area, all of the centroids C1 to C9 of areas laid within a circle centered at the centroid A of area with a radius of 10 μm.

The cylindrical member 6 was heated at 500° C. for 60 minutes to obtain the heated cylindrical member 6.

In terms of the heated cylindrical member 6, in the XY coordinate plane with the origin at the centroid K of area, the centroid Dmax of area was 14 μm away from the centroid K of area and laid outside of a circle centered at the centroid K of area with a radius of 10 μm. When the half line KDmax was made to coincide with the reference half line in the XY coordinate plane with the origin at the centroid K of area, some of the centroids D1 to D9 of areas laid in the first quadrant of the XY coordinate plane with the origin at the centroid K of area, some laid in the second quadrant, and some laid in the third quadrant.

The results are illustrated in Table 2.

### Example 5

### Preparation of Core Metal for Elastic Roller

A cylindrical member having a circularity of 5 μm or less before straightening was used.

The cylindrical member before straightening was straightened under the conditions of “Bend 7” described in Table 1 to obtain a cylindrical member 7 (a cylindrical member after straightening). In the straightening, the positions of the centroids C101 to C109 of areas were not reversed.

In terms of the resulting cylindrical member 7, in the XY coordinate plane with the origin at the centroid A of area, all of the centroids C1 to C9 of areas laid on or within a circle centered at the centroid A of area with a radius of 10 μm. An elastic roller for electrophotography using the straightened cylindrical member 7 as the core metal was produced as described below.

### Production of Elastic Roller

The cylindrical member 7 was used as the core metal 32.

To form the elastic layer by covering the core metal 32 with an unvulcanized rubber composition, which is the elastic layer forming material 42, an extrusion equipment available from Mitsuba MFG. Co., LTD. was used. The extrusion equipment includes the crosshead 41 having the structure illustrated in FIG. 11. An extruder of the extrusion equipment has a degassing port including the cylinder 44 having a bore (diameter) of 70 mm and the ratio of the length to the bore (diameter), that is, the length/bore of 20.

The molding temperature during extrusion was set to 100° C. for the cylinder, a screw, and a crosshead die. The screw rotation speed was set at 10 revolutions per minute. Under these conditions, the peripheral surface of the core metal 32 was covered with the elastic layer forming material 42.

The flow rate of the elastic layer forming material 42 that flowed into the crosshead 41 was kept constant at 5.20×10⁻⁴ mm³/sec. In terms of the feed rate of the core metal 32 fed into the crosshead 41 when the core metal 32 was covered with the elastic layer forming material 42, the feed rate used when a middle portion of the core metal 32 in the longitudinal direction was covered was set to 4.70 mm/sec, and the feed rate used when both end portions were covered was set to 5.80 mm/sec.

The elastic roller precursor was produced in this manner.

The thickness of the elastic layer forming material 42 layered around the core metal 32 immediately after the elastic layer forming material 42 was extruded from the crosshead 41 was measured using a laser measuring instrument. Feedback control of the feed rate for the core metal 32 was performed based on the relationship between the feed rate of the core metal 32 and the thickness, which was obtained beforehand in preliminary molding.

The obtained elastic roller precursor was heated in an air heating furnace at 160° C. for one hour. Thereafter, the layered elastic layer forming material 42 of the elastic roller precursor was removed 10 mm from both the ends and, thus, the elastic roller was obtained. The length of the elastic layer 33 in the longitudinal direction of the elastic roller was 230 mm.

### Surface Treatment of Elastic Roller

The surface of the obtained elastic roller was irradiated with ultraviolet light to obtain an elastic roller having a UV-treated region on the surface of the elastic layer 33. The UV irradiation was performed using a low-pressure mercury lamp (trade name: GLQ500US/11 available from Toshiba Lighting & Technology Corporation). The surface of the elastic roller was uniformly irradiated with UV light while the elastic roller was being rotated at a constant speed with the core metal 32 as a rotating shaft. The ultraviolet light quantity was set to 9000 mJ/cm² in terms of the sensitivity of a sensor for 254 nm.

### Image Evaluation and Observation of Soiling on Charge Roller

An elastic roller having a UV-treated region on its surface was incorporated into an electrophotographic apparatus as a charge roller, and a paper feeding endurance test was conducted in a low temperature and low humidity environment. A laser beam printer (product name: Laserjet M608dn available from HP Inc.) was prepared as an electrophotographic apparatus used for the paper feeding endurance test. To conduct the evaluation in a high-speed process, the laser beam printer was modified to output 75 sheets per minute (A4 vertical output), which was more than the original number of output sheets per unit time. The image resolution of the laser beam printer is 600 dpi, and the voltage applied to the charge roller was a DC voltage of −1100 V. As an electrophotographic process cartridge (hereinafter also simply referred to as a “process cartridge”), a process cartridge for the laser beam printer described above was used. The process cartridge includes a photosensitive drum and a charge roller disposed in contact with the photosensitive drum. A pressure of 250 g is applied to each of both ends of the core metal of the charge roller, which presses the charge roller against the photosensitive drum.

The elastic roller (the elastic roller having a UV-treated region on its surface), the electrophotographic apparatus, and the process cartridge were first left to stand in an environment at a temperature of 15° C. and a relative humidity of 10% for 48 hours to acclimate them to the measurement environment.

The elastic roller was then incorporated into the process cartridge as a charge roller. An output image was evaluated using the process cartridge.

More specifically, 1000 “E” character image sheets with a print density of 1% were consecutively output under a low temperature and low humidity environment (at a temperature of 15° C. and a relative humidity of 10%). After the 1000 image sheets were output, a halftone image (an image in which horizontal lines each having a width of 1 dot in a direction perpendicular to the rotation direction of the photosensitive drum were drawn at intervals of 2 dots) was output. The obtained image was observed by the eyes to check an image defect that originated from adhesion of soiling to the surface of the charge roller.

After the above-described halftone image was output, the surface of the charge roller was observed with a digital microscope (model number VH-8000 available from Keyence Corporation) to determine the degree of adhesion of soiling (toner and external additive). Two observation positions were set 10 mm inward from each of the two ends of the elastic layer 33. Whichever has worse adhesion of soiling was evaluated.

The result of observation of an image defect caused by the soiling adhesion to the halftone image and the result of microscopic observation of the surface of the charge roller were evaluated based on the criteria described in Table 3. The results are illustrated in Table 4.

After the evaluation, the elastic layer 33 was removed from the elastic roller to obtain the cylindrical member 7.

The cylindrical member 7 was heated at 500° C. for 60 minutes to obtain the heated cylindrical member 7.

In terms of the heated cylindrical member 7, in the XY coordinate plane with the origin at the centroid K of area, the centroid Dmax of area was 16 μm away from the centroid K of area and outside of a circle centered at the centroid K of area with a radius of 10 μm. When the half line KDmax was made to coincide with the reference half line in the XY coordinate plane with the origin at the centroid K of area, all of the centroids D1 to D9 of areas laid in the first quadrant of the XY coordinate plane with the origin at the centroid K of area.

### Comparative Example 3

A cylindrical member having a circularity of 5 μm or less before straightening was used.

The cylindrical member before straightening was straightened under the conditions of “Bend 8” described in Table 1 to obtain a cylindrical member 8 (a cylindrical member after straightening). In the straightening, the positions of the centroids C101 to C109 of areas were reversed.

In terms of the resulting cylindrical member 8, in the XY coordinate plane with the origin at the centroid A of area, all of the centroids C1 to C9 of areas laid within a circle centered at the centroid A of area with a radius of 10 μm.

An elastic roller for electrophotography was produced in the same manner as in Example 5, except that the cylindrical member 8 was used as the core metal instead of the cylindrical member 7 in Example 5, and the evaluation was made based on the criteria described in Table 3. The results are illustrated in Table 4.

After the evaluation was made, the elastic layer 33 was removed from the elastic roller to obtain the cylindrical member 8.

The cylindrical member 8 was heated at 500° C. for 60 minutes to obtain the heated cylindrical member 8.

In terms of the heated cylindrical member 8, in the XY coordinate plane with the origin at the centroid K of area, the centroid Dmax of area was 15 μm away from the centroid K of area and outside of a circle centered at the centroid K of area with a radius of 10 μm. When the half line KDmax was made to coincide with the reference half line in the XY coordinate plane with the origin at the centroid K of area, some of the centroids D1 to D9 of areas laid in the first quadrant of the XY coordinate plane with the origin at the centroid K of area, some laid in the second quadrant, and some laid in the third quadrant.

TABLE 1

| | Bend 1 | Bend 2 | Bend 3 | Bend 4 | Bend 5 | Bend 6 | Bend 7 | Bend 8 |
|---|---|---|---|---|---|---|---|---|
| Distance of | 17 | 18 | 16 | 19 | 19 | 18 | 17 | 16 |
| Cmax from | | | | | | | | |
| origin before | | | | | | | | |
| straightening | | | | | | | | |
| (μm) | | | | | | | | |
| Distance of | 8 | 10 | 7 | 10 | 7 | 6 | 10 | 6 |
| Cmax from | | | | | | | | |
| origin after | | | | | | | | |
| straightening | | | | | | | | |
| (μm) | | | | | | | | |
| Circularity | 7 | 7 | 3 | 3 | 3 | 3 | 4 | 3 |
| (μm) | | | | | | | | |
| (before | | | | | | | | |
| straightening) | | | | | | | | |
| Quadrant | not | not | not | not | reversed | reversed | not | reversed |
| positions of | reversed | reversed | reversed | reversed | | | reversed | |
| C1 to C9 after | | | | | | | | |
| straightening | | | | | | | | |

TABLE 2

| | Example | Example | Example | Example | Comparative | Comparative |
|---|---|---|---|---|---|---|
| | 1 | 2 | 3 | 4 | Example 1 | Example 2 |
| Distance of | 8 | 10 | 7 | 10 | 7 | 6 |
| Cmax from | | | | | | |
| origin (μm) | | | | | | |
| (before heating) | | | | | | |
| Distance of | 15 | 17 | 14 | 17 | 13 | 14 |
| Dmax from | | | | | | |
| origin (μm) | | | | | | |
| (after heating) | | | | | | |
| Quadrant | 1 | 1 | 1 | 1 | 1, 2, 3 | 1, 2, 3 |
| positions of D1 | | | | | | |
| to D9 | | | | | | |
| Circularity | 8 | 7 | 4 | 5 | 7 | 3 |
| (μm) | | | | | | |
| (after heating) | | | | | | |

TABLE 3

| | | Half-tone image |
|---|---|---|
| | Roller surface | Observation Result |
| | Observation Result | (Defect caused by |
| Rank | (Adhesion of soiling) | adhesion of soiling) |
| 1 | Extremely slight | None |
| 2 | Slight | Extremely slight |
| 3 | Present | Slight |
| 4 | Prominent | Present |
| 5 | Extremely prominent | Prominent |

TABLE 4

| | | Comparative |
|---|---|---|
| | Example 5 | Example 3 |
| Distance of Cmax from origin (μm) | 10 | 6 |
| (before heating) | | |
| Distance of Dmax from origin (μm) | 16 | 15 |
| (after heating) | | |
| Quadrant positions of D1 to D9 | 1 | 1, 2, 3 |
| Circularity (μm) | 4 | 4 |
| (after heating) | | |
| Roller surface Observation Result | 1 | 5 |
| (Adhesion of soiling) | | |
| Half-tone image Observation Result | 1 | 4 |
| (Defect caused by adhesion of soiling) | | |

As described above, the present disclosure can provide a cylindrical member with low runout and low nonuniformity of physical properties (the degree of work hardening) in the longitudinal direction.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-106837 filed Jul. 2, 2024, which is hereby incorporated by reference herein in its entirety.

What is claimed is:

1. A cylindrical member made of metal, wherein
let A denote a centroid of area of one end surface of the cylindrical member,
let B denote a centroid of area of another end surface,
let Z-axis denote a line passing through the centroid A of area and the centroid B of area,
let Y-axis denote a line perpendicular to the Z-axis,
let X-axis denote a line perpendicular to the Z-axis and the Y-axis,
let AB denote a line segment connecting the centroid A of area to the centroid B of area,
let E1 to E9 denote nine points that divide the line segment AB into 10 equal parts from a side adjacent to the centroid A of area,
let Q1 to Q9 denote nine planes each including any one of the points E1 to E9 and parallel to the Y-axis,
let S1 to S9 denote nine virtual cross sections obtained by virtually cutting the cylindrical member by the planes Q1 to Q9, respectively, and
let C1 to C9 denote centroids of areas of the virtual cross sections S1 to S9, respectively,
then when positions of the centroids C1 to C9 of areas relative to the centroid A of area are plotted on an XY coordinate plane having an origin at the centroid A of area, all of the centroids C1 to C9 of areas lie on or within a circle centered at the centroid A of area with a radius of 10 μm in the XY coordinate plane having an origin at the centroid A of area,
wherein after the cylindrical member is heated until a temperature of the entire cylindrical member reaches a recrystallization temperature of the metal to obtain the heated cylindrical member,
let K denote a centroid of area of one end surface of the heated cylindrical member on the same side as the centroid A of area,
let L denote a centroid of area of the other end surface on the same side as the centroid B of area,
let Z-axis denote a line passing through the centroid K of area and the centroid L of area,
let Y-axis denote a line perpendicular to the Z-axis,
let X-axis denote a line perpendicular to the Z-axis and the Y-axis,
let KL denote a line segment connecting the centroid K of area to the centroid L of area,
let F1 to F9 denote nine points that divide the line segment KL into 10 equal parts from a side adjacent to the centroid K of area,
let R1 to R9 denote nine planes each including any one of the points F1 to F9 and parallel to the Y-axis,
let T1 to T9 denote nine virtual cross sections obtained by virtually cutting the heated cylindrical member by the planes R1 to R9, respectively, and
let D1 to D9 denote centroids of areas of the virtual cross sections T1 to T9, respectively,
then when positions of the centroids D1 to D9 of areas relative to the centroid K of area are plotted on the XY coordinate plane having the origin at the centroid K of area, at least one of the centroids D1 to D9 of areas lies outside of a circle centered at the centroid K of area with a radius of 10 μm in the XY coordinate plane having an origin at the centroid K of area, and
wherein let Dmax denote the farthest one out of the centroids D1 to D9 of areas from the centroid K of area,
let KDmax denote a half line passing through the centroid K of area and the centroid Dmax of area and having an end point at the centroid K of area, and
let a reference half line be a half line that lies in a first quadrant of the XY coordinate plane having the origin at the centroid K of area and passes through the centroid K of area and that has an end point at the centroid K of area and has a slope of 1,
then when the half line KDmax is made to coincide with the reference half line, all of the centroids D1 to D9 of areas in the XY coordinate plane having an origin at the centroid K of area lie in the first quadrant of the XY coordinate plane having an origin at the centroid K of area.

2. The cylindrical member according to claim 1, wherein a circularity of the cylindrical member is less than or equal to 5 μm.

3. An elastic roller for electrophotography comprising:
a core metal; and
an elastic layer configured to cover a peripheral surface of the core metal,
wherein the core metal is a cylindrical member made of metal,
wherein let A denote a centroid of area of one end surface of the cylindrical member,
let B denote a centroid of area of another end surface,
let Z-axis denote a line passing through the centroid A of area and the centroid B of area,
let Y-axis denote a line perpendicular to the Z-axis,
let X-axis denote a line perpendicular to the Z-axis and the Y-axis,
let AB denote a line segment connecting the centroid A of area to the centroid B of area,
let E1 to E9 denote nine points that divide the line segment AB into 10 equal parts from a side adjacent to the centroid A of area,
let Q1 to Q9 denote nine planes each including any one of the points E1 to E9 and parallel to the Y-axis,
let S1 to S9 denote nine virtual cross sections obtained by virtually cutting the cylindrical member by the planes Q1 to Q9, respectively, and
let C1 to C9 denote centroids of areas of the virtual cross sections S1 to S9, respectively,
then when positions of the centroids C1 to C9 of areas relative to the centroid A of area are plotted on an XY coordinate plane having an origin at the centroid A of area,
all of the centroids C1 to C9 of areas lie on or within a circle centered at the centroid A of area with a radius of 10 μm in the XY coordinate plane having an origin at the centroid A of area,
wherein after the cylindrical member is heated until a temperature of the entire cylindrical member reaches a recrystallization temperature of the metal to obtain the heated cylindrical member,
let K denote a centroid of area of one end surface of the heated cylindrical member on the same side as the centroid A of area,
let L denote a centroid of area of the other end surface on the same side as the centroid B of area,
let Z-axis denote a line passing through the centroid K of area and the centroid L of area, let Y-axis denote a line perpendicular to the Z-axis,
let X-axis denote a line perpendicular to the Z-axis and the Y-axis,
let KL denote a line segment connecting the centroid K of area to the centroid L of area,
let F1 to F9 denote nine points that divide the line segment KL into 10 equal parts from a side adjacent to the centroid K of area,
let R1 to R9 denote nine planes each including any one of the points F1 to F9 and parallel to the Y-axis,
let T1 to T9 denote nine virtual cross sections obtained by virtually cutting the heated cylindrical member by the planes R1 to R9, respectively, and
let D1 to D9 denote centroids of areas of the virtual cross sections T1 to T9, respectively,
then when positions of the centroids D1 to D9 of areas relative to the centroid K of area are plotted on the XY coordinate plane having the origin at the centroid K of area,
at least one of the centroids D1 to D9 of areas lies outside of a circle centered at the centroid K of area with a radius of 10 μm in the XY coordinate plane having an origin at the centroid K of area, and
wherein let Dmax denote the farthest one out of the centroids D1 to D9 of areas from the centroid K of area,
let KDmax denote a half line passing through the centroid K of area and the centroid Dmax of area and having an end point at the centroid K of area, and
let a reference half line be a half line that lies in a first quadrant of the XY coordinate plane having the origin at the centroid K of area and passes through the centroid K of area and that has an end point at the centroid K of area and has a slope of 1,
then when the half line KDmax is made to coincide with the reference half line, all of the centroids D1 to D9 of areas in the XY coordinate plane having an origin at the centroid K of area lie in the first quadrant of the XY coordinate plane having an origin at the centroid K of area.

4. A process cartridge comprising:
a photosensitive drum; and
a charge roller disposed in contact with the photosensitive drum,
wherein the charge roller is an elastic roller including a core metal and an elastic layer covering a peripheral surface of the core metal,
wherein the core metal is a cylindrical member made of metal,
wherein let A denote a centroid of area of one end surface of the cylindrical member,
let B denote a centroid of area of another end surface,
let Z-axis denote a line passing through the centroid A of area and the centroid B of area,
let Y-axis denote a line perpendicular to the Z-axis,
let X-axis denote a line perpendicular to the Z-axis and the Y-axis,
let AB denote a line segment connecting the centroid A of area to the centroid B of area,
let E1 to E9 denote nine points that divide the line segment AB into 10 equal parts from a side adjacent to the centroid A of area,
let Q1 to Q9 denote nine planes each including any one of the points E1 to E9 and parallel to the Y-axis,
let S1 to S9 denote nine virtual cross sections obtained by virtually cutting the cylindrical member by the planes Q1 to Q9, respectively, and
let C1 to C9 denote centroids of areas of the virtual cross sections S1 to S9, respectively,
then when positions of the centroids C1 to C9 of areas relative to the centroid A of area are plotted on an XY coordinate plane having an origin at the centroid A of area,
all of the centroids C to C9 of areas lie on or within a circle centered at the centroid A of area with a radius of 10 μm in the XY coordinate plane having an origin at the centroid A of area,
wherein after the cylindrical member is heated until a temperature of the entire cylindrical member reaches a recrystallization temperature of the metal to obtain the heated cylindrical member,
let K denote a centroid of area of one end surface of the heated cylindrical member on the same side as the centroid A of area,
let L denote a centroid of area of the other end surface on the same side as the centroid B of area,
let Z-axis denote a line passing through the centroid K of area and the centroid L of area,
let Y-axis denote a line perpendicular to the Z-axis,
let X-axis denote a line perpendicular to the Z-axis and the Y-axis,
let KL denote a line segment connecting the centroid K of area to the centroid L of area,
let F1 to F9 denote nine points that divide the line segment KL into 10 equal parts from a side adjacent to the centroid K of area,
let R1 to R9 denote nine planes each including any one of the points F1 to F9 and parallel to the Y-axis,
let T1 to T9 denote nine virtual cross sections obtained by virtually cutting the heated cylindrical member by the planes R1 to R9, respectively, and
let D1 to D9 denote centroids of areas of the virtual cross sections T1 to T9, respectively, then when positions of the centroids D1 to D9 of areas relative to the centroid K of area are plotted on the XY coordinate plane having the origin at the centroid K of area, at least one of the centroids D1 to D9 of areas lies outside of a circle centered at the centroid K of area with a radius of 10 μm in the XY coordinate plane having an origin at the centroid K of area, and
wherein let Dmax denote the farthest one out of the centroids D1 to D9 of areas from the centroid K of area,
let KDmax denote a half line passing through the centroid K of area and the centroid Dmax of area and having an end point at the centroid K of area, and
let a reference half line be a half line that lies in a first quadrant of the XY coordinate plane having the origin at the centroid K of area and passes through the centroid K of area and that has an end point at the centroid K of area and has a slope of 1,
then when the half line KDmax is made to coincide with the reference half line, all of the centroids D1 to D9 of areas in the XY coordinate plane having an origin at the centroid K of area lie in the first quadrant of the XY coordinate plane having an origin at the centroid K of area.

5. An electrophotographic apparatus comprising:
a photosensitive drum; and
a charge roller disposed in contact with the photosensitive drum,
wherein the charge roller is an elastic roller including a core metal and an elastic layer covering a peripheral surface of the core metal,
wherein the core metal is a cylindrical member made of metal,
wherein let A denote a centroid of area of one end surface of the cylindrical member,
let B denote a centroid of area of another end surface,
let Z-axis denote a line passing through the centroid A of area and the centroid B of area,
let Y-axis denote a line perpendicular to the Z-axis,
let X-axis denote a line perpendicular to the Z-axis and the Y-axis,
let AB denote a line segment connecting the centroid A of area to the centroid B of area,
let E1 to E9 denote nine points that divide the line segment AB into 10 equal parts from a side adjacent to the centroid A of area,
let Q1 to Q9 denote nine planes each including any one of the points E1 to E9 and parallel to the Y-axis,
let S1 to S9 denote nine virtual cross sections obtained by virtually cutting the cylindrical member by the planes Q1 to Q9, respectively, and
let C1 to C9 denote centroids of areas of the virtual cross sections S1 to S9, respectively,
then when positions of the centroids C1 to C9 of areas relative to the centroid A of area are plotted on an XY coordinate plane having an origin at the centroid A of area,
all of the centroids C1 to C9 of areas lie on or within a circle centered at the centroid A of area with a radius of 10 μm in the XY coordinate plane having an origin at the centroid A of area,
wherein after the cylindrical member is heated until a temperature of the entire cylindrical member reaches a recrystallization temperature of the metal to obtain the heated cylindrical member,
let K denote a centroid of area of one end surface of the heated cylindrical member on the same side as the centroid A of area,
let L denote a centroid of area of the other end surface on the same side as the centroid B of area,
let Z-axis denote a line passing through the centroid K of area and the centroid L of area,
let Y-axis denote a line perpendicular to the Z-axis,
let X-axis denote a line perpendicular to the Z-axis and the Y-axis,
let KL denote a line segment connecting the centroid K of area to the centroid L of area,
let F1 to F9 denote nine points that divide the line segment KL into 10 equal parts from a side adjacent to the centroid K of area,
let R1 to R9 denote nine planes each including any one of the points F1 to F9 and parallel to the Y-axis,
let T1 to T9 denote nine virtual cross sections obtained by virtually cutting the heated cylindrical member by the planes R1 to R9, respectively, and
let D1 to D9 denote centroids of areas of the virtual cross sections T1 to T9, respectively,
then when positions of the centroids D1 to D9 of areas relative to the centroid K of area are plotted on the XY coordinate plane having the origin at the centroid K of area,
at least one of the centroids D1 to D9 of areas lies outside of a circle centered at the centroid K of area with a radius of 10 μm in the XY coordinate plane having an origin at the centroid K of area, and
wherein let Dmax denote the farthest one out of the centroids D1 to D9 of areas from the centroid K of area,
let KDmax denote a half line passing through the centroid K of area and the centroid Dmax of area and having an end point at the centroid K of area, and
let a reference half line be a half line that lies in a first quadrant of the XY coordinate plane having the origin at the centroid K of area and passes through the centroid K of area and that has an end point at the centroid K of area and has a slope of 1,
then when the half line KDmax is made to coincide with the reference half line,
all of the centroids D1 to D9 of areas in the XY coordinate plane having an origin at the centroid K of area lie in the first quadrant of the XY coordinate plane having an origin at the centroid K of area.
